(19) United States
(12) Patent Application Publication
(10) Pub. No.: US 2025/0158084 A1
(43) Pub. Date: May 15, 2025

(54) PLATINUM-RHENIUM ALLOY CATALYST, PREPARATION METHOD, AND FUEL CELL

(71) Applicant: CHINA UNIVERSITY OF PETROLEUM-BEIJING, Beijing (CN)

(72) Inventors: Guoyong HUANG, Beijing (CN); Chunxia WANG, Beijing (CN); Jian CUI, Beijing (CN); Maolin TIAN, Beijing (CN); Jiawei WEN, Beijing (CN); Fengshan YU, Beijing (CN)

(21) Appl. No.: 18/762,779

(22) Filed: Jul. 3, 2024

(30) Foreign Application Priority Data
Nov. 10, 2023 (CN) 202311498405.8

(51) Int. Cl. H01M 4/92; H01M 4/86

(52) U.S. Cl. CPC H01M 4/926; H01M 2004/8689

(57) ABSTRACT

A platinum-rhenium alloy catalyst preparation method includes the following steps: (1) dispersing a carbon carrier, a platinum source and an alkaline substance in ethylene glycol for microwave reaction, acidizing and depositing the solution after the reaction is finished, washing with water, and drying to obtain a Pt/C precursor; (2) dispersing the Pt/C precursor, a phosphorus source and a rhenium precursor in water, carrying out ultrasonic treatment, drying by distillation after treatment, and grinding to obtain a platinum-rhenium alloy catalyst precursor; and (3) calcining the platinum-rhenium alloy catalyst precursor in an inert atmosphere, and grinding after the calcining to obtain a platinum-rhenium alloy catalyst. The platinum-rhenium alloy catalyst is prepared through a two-step method, rhenium and platinum are alloyed through high-temperature pyrolysis of the phosphorus source, thus solving the problem that simultaneous reduction is difficult due to the reduction potential difference of platinum and rhenium.

### TECHNICAL FIELD

The present invention belongs to the field of fuel cell ally catalyst preparation, and specifically relates to a platinum-rhenium alloy catalyst, a preparation method and a fuel cell.

### BACKGROUND

Hydrogen energy is regarded as the clean energy with the greatest potential for development in the 21st century due to its diverse sources, clean low-carbon, flexibility, efficiency, and rich application scenarios. In addition, hydrogen energy has become the preferred direction of a new round of carbon emission reduction and carbon neutrality, and has been included in the energy strategic deployment by many countries. A fuel cell is an energy conversion device that can efficiently utilize hydrogen energy. It has the advantages of high conversion efficiency and zero emissions. It can use electrochemical reactions to directly convert the chemical energy stored in the fuel into electrical energy. Its basic reactions are an oxygen reduction reaction occurring at the cathode and an oxidation of the fuel occurring at the anode. Among them, the kinetics of the oxygen reduction reaction at the cathode is extremely slow, and thus the amount of catalyst required at the cathode is much higher than that at the anode. The development of fuel cell oxygen reduction electrocatalysts with high activity and durability is of great significance for the wide application of fuel cell technology.

Currently, platinum-on-carbon (Pt/C) catalyst is the most widely used fuel cell catalyst in commercial applications. Its structure is simple and conducive to large-scale production. However, it is limited by the precious metal platinum resource reserves, and it is necessary to develop high-efficiency fuel cells with low platinum loading. Catalysts, in which the alloying of platinum with other metals, have been proven to be an effective means to improve the catalytic effect while reducing the amount of platinum. The enhanced activity of the Pt-based alloy catalyst is mainly due to the change in the geometric structure and electronic structure of Pt atoms by other metals, and different metals produce different effects depending on their properties.

The price of rhenium (Re) is relatively low, and Re has been used in electronic devices, catalysis, aerospace and other fields. In the field of electrocatalysis, Re shows catalytic activity close to that of Pt, but its low redox potential (E/V=0.368) limits its application. Re is difficult to be reduced in traditional wet chemical methods. In particular, platinum-rhenium alloys are difficult to synthesize in one pot and one step.

### SUMMARY OF THE INVENTION

In order to solve the above technical problem, the present invention provides a platinum-rhenium alloy catalyst, a preparation method and a fuel cell. The PtRe/PC catalyst is synthesized through a two-step method. First, a Pt/C precursor is synthesized through a microwave-assisted ethylene glycol method; second, the Pt/C precursor is immersed in a water phase with a phosphorus source and a rhenium precursor, and then evaporated. The evaporated product is obtained by drying, and the evaporated product is calcined at high temperature under a specific atmosphere to fully alloy the rhenium precursor and platinum to obtain a phosphorus-doped PtRe/PC catalyst. This method is synthesized through a two-step method, which solves the problem of difficulty in simultaneously reducing platinum and rhenium in a one-pot wet chemical method. The decomposition products of the phosphorus source at high temperatures drive the reduction of rhenium and its alloying with platinum. This method has simple steps, and the prepared PtRe/PC catalyst can be used as an efficient platinum-based catalyst for fuel cell.

In a first aspect, the present invention provides a method for preparing platinum-rhenium alloy catalyst, which includes the following steps:
(1) dispersing a carbon carrier, a platinum source and an alkaline substance in ethylene glycol for microwave reaction, acidizing and depositing the solution after the reaction is finished, washing with water, and drying to obtain a Pt/C precursor;
(2) dispersing the Pt/C precursor, a phosphorus source and a rhenium precursor in water, carrying out ultrasonic treatment, drying by distillation after the ultrasonic treatment, and grinding to obtain a platinum-rhenium alloy catalyst precursor; and
(3) calcining the platinum-rhenium alloy catalyst precursor in an inert atmosphere, and grinding after treatment to obtain the platinum-rhenium alloy catalyst.

In the above method for preparing platinum-rhenium alloy catalyst, the carbon carrier may be carbon black, specifically at least one of VulcanXC-72R, EC-300J, EC-600J, and BP2000;
the platinum source may be at least one of chloroplatinic acid, potassium chloroplatinate, sodium chloroplatinate, and platinum acetylacetonate;
the alkaline substance may be at least one of sodium hydroxide, potassium hydroxide, and ammonia water;
a molar ratio of the platinum source to the alkaline substance may be 1:(20-110), specifically 1:20, 1:50, 1:80, or 1:110;
a volume ratio of the total mass of the carbon carrier, the platinum source and the alkaline substance to the ethylene glycol is (2-20) mg:1 mL, specifically (5-10) mg:1 mL, 9.2 mg:1 mL, 13.7 mg:1 mL, 6.3 mg:1 mL, 5.4 mg:1 mL, 7 mg:1 mL, or 7.2 mg:1 mL;

In at least one embodiment of the present invention, the steps of dispersing the carbon carrier, the platinum source and the alkaline substance in ethylene glycol are as follows. the carbon carrier was dispersed in ethylene glycol, and an ethylene glycol solution of the platinum source is added dropwise during stirring; every 80 mg of the carbon carrier is dispersed in (25-50) mL of ethylene glycol (such as 25 mL, 35 mL, or 50 mL), a concentration of the ethylene glycol solution of the platinum source is 4 mgPt/mL, and a concentration of the ethylene glycol solution of the alkaline substance is 1 mol/L;
a power of the microwave reaction can be 600-900 W, specifically 700-900 W, 700 W, or 900 W; the temperature can be 130-190° C., specifically 140-180° C., 140° C., 160° C., or 180° C.; a time can be 2 min-30 min, specifically can be 2-10 min, 2 min, 5 min, or 10 min.

In the above method for preparing platinum-rhenium alloy catalyst, preferably, in the step of the acidizing and depositing, an acid is added to the solution to adjust the pH value of the solution to 2 to 4, such as 2, 3, or 4;
the acid can be at least one of dilute hydrochloric acid, dilute nitric acid, and dilute sulfuric acid, and the concentration can be 0.5 mol/L;
a time of the acidizing and depositing can be 5 to 24 hours, specifically 20 hours, 10 hours, 15 hours, or 24 hours;
the drying can specifically be freeze drying or vacuum drying, and a temperature of the vacuum drying can be specifically 60-70° C., 60° C., or 70° C.

In the above method for preparing platinum-rhenium alloy catalyst, the phosphorus source may be at least one of phosphoric acid, sodium hydrogen phosphate, sodium dihydrogen phosphate, and sodium hydrogen hypophosphite;
the rhenium precursor may be at least one of perrhenic acid, sodium perrhenate, rhenium trichloride, and rhenium oxide;
a molar ratio of the phosphorus source to the rhenium precursor may be 1:(0.1-2), specifically 1:0.4, 1:1, 3:1, or 2:1.

In the above method for preparing platinum-rhenium alloy catalyst, the total mass of the Pt/C precursor, the phosphorus source and the rhenium precursor and the volume of water can be (5-30) mg:1 mL, specifically, it can be (10-12 mg):1 mL, 10.5 mg:1 mL, 11.1 mg:1 mL, 11.3 mg: 1 mL, 10.7 mg:1 mL, or 10.1 mg:1 mL;

In at least one embodiment of the present invention, the step of dispersing the Pt/C precursor, the phosphorus source, and the rhenium precursor in water is as follows: adding an aqueous solution of the phosphorus source and an aqueous solution of the rhenium source to an aqueous suspension of the Pt/C precursor; wherein, a concentration of the aqueous solution of the phosphorus source is 0.1 mol/L, a concentration of the aqueous solution of the rhenium source is 0.1 mol/L, and a concentration of the Pt/C precursor suspension is 10 mg/mL;
a power of the ultrasonic treatment can be 500-1000 W, such as 500 W, and the time can be 30-120 minutes, such as 120 min;
the evaporation to dryness can be performed specifically at 60° C. to 70° C., such as 60° C. or 70° C.

In the above method for preparing platinum-rhenium alloy catalyst, the inert atmosphere is nitrogen, argon or a hydrogen-argon mixture;
conditions for the calcination treatment are as follows: heating to 600-1100° C. (such as 700° C., 900° C., 1100° C., 800° C. or 600° C.) at a heating rate of 2-5° C./min (such as 5° C./min), and holding for 1-4 h (such as 1-2 h, 2 h, 1 h, 1.5 h).

In the above method for preparing platinum-rhenium alloy catalyst, based on the total amount of the platinum-rhenium alloy catalyst, the total mass percentage of platinum and rhenium metal can be 10% to 40%, specifically 18% to 27%, 25.54%, 18.77%, 18.85%, 26.81%, 26.77%, or 26.89%. In the platinum-rhenium alloy catalyst, platinum-rhenium alloy nanoparticles are evenly dispersed on the carbon carrier.

In the above method for preparing platinum-rhenium alloy catalyst, in the platinum-rhenium alloy catalyst, a molar ratio of platinum to rhenium can be (1-3):1, specifically (1-2.5):1, 2.5:1, 1:1, or 2:1. In the platinum-rhenium alloy catalyst, the two metals platinum and rhenium can be fully alloyed.

In the above method for preparing platinum-rhenium alloy catalyst, the platinum-rhenium alloy catalyst is a platinum-rhenium alloy catalyst used for fuel cell.

In a second aspect, the present invention provides a platinum-rhenium alloy catalyst prepared by the method for preparing platinum-rhenium alloy catalyst described in any one of the above.

In a third aspect, the present invention provides a hydrogen fuel cell, including a cathode, an anode and an electrolyte, in which the cathode contains the platinum-rhenium alloy catalyst.

Compared with the prior art, the present invention has the following beneficial effects:

(1) The present invention prepares a platinum-rhenium alloy catalyst through a two-step method. The phosphorus source is pyrolyzed at high temperature to alloy rhenium and platinum. This solves the problem of difficulty in simultaneous reduction of platinum and rhenium due to the difference in reduction potential of platinum and rhenium, and provides new ideas for preparing platinum-rhenium alloy.

(2) The present invention uses relatively cheap rhenium with platinum to form alloy. The prepared platinum-rhenium alloy catalyst not only reduces the use of platinum resources, but also the introduction of rhenium adjusts the electronic structure of platinum and improves the catalytic ability.

(3) The presence of heteroatom phosphorus in the phosphorus-doped carbon carrier of the electrocatalyst of the present invention can not only create new active sites, but also enhance the anchoring ability of the carrier to platinum-rhenium nanoparticles.

(4) The preparation method of the present invention is environmentally friendly and suitable for large-scale production.

### BRIEF DESCRIPTION OF THE DRAWINGS

FIG. 1 is a process flow chart of a method for preparing platinum-rhenium alloy catalyst for fuel cell in an embodiment of the present invention.

FIG. 2 is the XRD pattern of the PtRe/PC catalyst prepared in Example 1.

FIG. 3 is a linear polarization curve of the oxygen reduction reaction of the PtRe/PC catalyst prepared in Example 1.

### DETAILED DESCRIPTION

The present invention will be described in further detail below with reference to specific embodiments. The examples given are only for illustrating the present invention and are not intended to limit the scope of the present invention. The examples provided below can serve as a guide for those of ordinary skill in the art to make further improvements, and do not limit the present invention in any way.

The experimental methods used in the following examples are conventional methods unless otherwise specified; the materials, reagents, etc. used can be obtained from commercial sources unless otherwise specified.

In the following examples, the mass activity (MA, A/mgPt) is calculated as follows:

$$1 / j = 1 / jk + 1 / jL$$

$$MA = jk * S / MPt$$

Among them, j represents the experimentally measured current density (mA/cm2); jk represents the dynamic current density (mA/cm2); jL is the experimentally measured limiting current diffusion density (mA/cm2). S is the electrode area (cm2). MPt is the loading amount of platinum (g).

### Example 1

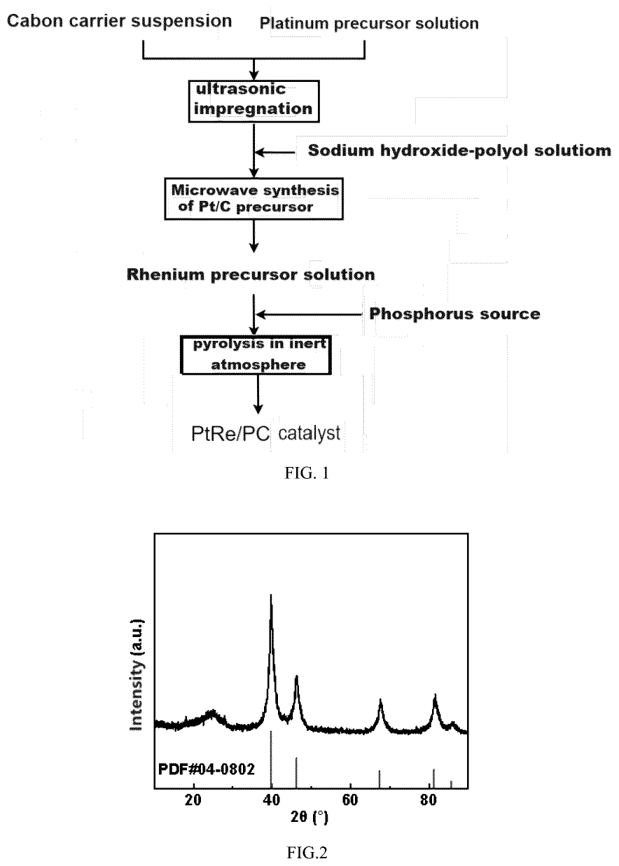

A PtRe/PC alloy catalyst was prepared according to the flow chart shown in FIG. 1. The specific steps were as follows.

(1) 80 mg of Vulcan XC-72R carbon black was took and dispersed ultrasonically in 25 mL of ethylene glycol for 30 minutes. During the stirring process, to the resulting mixture was added dropwise 5 mL of chloroplatinic acid-ethylene glycol solution with a concentration of 4 mgPt/mL, and then added dropwise 5 mL of sodium hydroxide-ethylene glycol solution with a concentration of 1 mol/L (the molar ratio of chloroplatinic acid to sodium hydroxide is 1:50), and the resulting uniform slurry was transferred to a microwave reactor and reacted at 160° C. for 2 min with a power of 900 W.

(2) After the reacted solution was naturally cooled to room temperature, to the resulting mixture was added 0.5 mol/L dilute sulfuric acid solution to adjust the pH to about 2. The platinum nanoparticles were deposited in the acidic environment for 20 hours, and then rinsed with a large amount of deionized water. A Pt/C precursor was obtained by freeze-drying.

(3) 1 mL of sodium dihydrogen phosphate solution with a concentration of 0.1 mol/L and 0.4 mL of rhenium trichloride solution with a concentration of 0.1 mol/L were took, and added to a 10 mL suspension of the Pt/C precursor (its concentration was 10 mg/mL). Ultrasonic treatment was carried out for 120 min with a power of 500 W, followed by drying at 60° C., grinding and crushing.

(4) The powder was calcined at 700° C. for 120 minutes under a N2 atmosphere with a heating rate of 5° C./min, then naturally cooled to room temperature, and ground to obtain a PtRe/PC alloy catalyst (based on the total amount of platinum-rhenium alloy catalyst, the total mass percentage of platinum and rhenium metal was 25.54 wt %, the molar ratio of platinum to rhenium was 2.49:1).

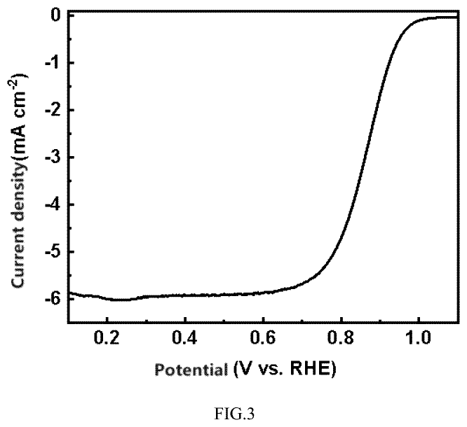

The XRD pattern of the PtRe/PC alloy catalyst prepared in this example is shown in FIG. 2, from which it can be seen that the PtRe/PC alloy catalyst still exhibits the face-centered cubic structure of the platinum lattice, and the introduction of surface rhenium will not cause changes in the platinum lattice. The contents of platinum and rhenium were determined by inductively coupled plasma optical emission spectrometry (ICP-OES). The total mass percentages of platinum and rhenium and the molar ratio of platinum to rhenium are summarized in Table 1. The above tests indicate that the platinum alloy catalyst was successfully prepared.

The ORR catalytic activity of the PtRe/PC alloy catalyst prepared in this example was tested. The test conditions were as follows: 2.5 mg of the catalyst sample was dispersed in 1 mL of a 3:1 mixed solution of isopropyl alcohol and water, and 0.5 wt % Nafion solution (20 μL) was added as a binder. Then, ultrasonic treatment was performed for 1 hour to form a homogeneous catalyst ink, and 10 μL of the catalyst ink was transferred to a rotating disk electrode to dryness. In the electrolyte of O2 saturated 0.1M HClO4, a standard three-electrode system (Hg/HgSO4 was used as the reference electrode, a platinum wire was used as the counter electrode, and a rotating disk electrode (diameter 5 mm) was used as the working electrode) was used. The ORR polarization curve of the PtRe/PC alloy catalyst prepared in this example is shown in FIG. 3. It can be seen from FIG. 3 that the half-wave potential (E1/2=0.8622V) relative to the standard hydrogen electrode), the mass activity (mass activity, MA) was 0.382 A/mgPt, indicating that the PtRe/PC alloy catalyst of this system had an excellent ORR catalytic activity.

### Example 2

A PtRe/PC alloy catalyst was prepared according to the flow chart shown in FIG. 1. The specific steps were as follows.

(1) 80 mg of Vulcan XC-72R carbon black was took and dispersed ultrasonically in 25 mL of ethylene glycol for 30 minutes. During the stirring process, to the resulting mixture was added dropwise 5 mL of chloroplatinic acid-ethylene glycol solution with a concentration of 4 mgPt/mL, and then added dropwise 11 mL of sodium hydroxide-ethylene glycol solution with a concentration of 1 mol/L (the molar ratio of chloroplatinic acid to sodium hydroxide is 1:110), and the resulting uniform slurry was transferred to a microwave reactor and reacted at 180° C. for 5 min with a power of 900 W.

(2) After the reacted solution was naturally cooled to room temperature, to the resulting mixture was added 0.5 mol/L dilute nitric acid solution to adjust the pH to about 3. The platinum nanoparticles were deposited in the acidic environment for 20 hours, and then rinsed with a large amount of deionized water. A Pt/C precursor was obtained by freeze-drying.

(3) 1 mL of disodium hydrogen phosphate solution with a concentration of 0.1 mol/L and 1 mL of perrhenic acid solution with a concentration of 0.1 mol/L were took, and added to a 10 mL suspension of the Pt/C precursor (its concentration was 10 mg/mL). Ultrasonic treatment was carried out for 120 min with a power of 500 W, followed by drying at 60° C., grinding and crushing.

(4) The powder was calcined at 900° C. for 120 minutes under an Ar2 atmosphere with a heating rate of 5° C./min, then naturally cooled to room temperature, and ground to obtain a PtRe/PC alloy catalyst (based on the total amount of platinum-rhenium alloy catalyst, the total mass percentage of platinum and rhenium metal was 18.77 wt %, the molar ratio of platinum to rhenium was 1.02:1).

### Example 3

A PtRe/PC alloy catalyst was prepared according to the flow chart shown in FIG. 1. The specific steps were as follows.

(1) 80 mg of Vulcan XC-72R carbon black was took and dispersed ultrasonically in 25 mL of ethylene glycol for 30 minutes. During the stirring process, to the resulting mixture was added dropwise 5 mL of chloroplatinic acid-ethylene glycol solution with a concentration of 4 mgPt/mL, and then added dropwise 2 mL of potassium hydroxide-ethylene glycol solution with a concentration of 1 mol/L (the molar ratio of chloroplatinic acid to potassium hydroxide is 1:20), and the resulting uniform slurry was transferred to a microwave reactor and reacted at 140° C. for 10 min with a power of 900 W.

(2) After the reacted solution was naturally cooled to room temperature, to the resulting mixture was added 0.5 mol/L dilute nitric acid solution to adjust the pH to about 3. The platinum nanoparticles were deposited in the acidic environment for 10 hours, and then rinsed with a large amount of deionized water. A Pt/C precursor was obtained by vacuum drying at 70° C.

(3) 2 mL of phosphoric acid solution with a concentration of 0.1 mol/L and 1 mL of sodium perrhenate solution with a concentration of 0.1 mol/L were took, and added to a 10 mL suspension of the Pt/C precursor (its concentration was 10 mg/mL). Ultrasonic treatment was carried out for 120 min with a power of 500 W, followed by drying at 60° C., grinding and crushing.

(4) The powder was calcined at 1100° C. for 60 minutes under an Ar2 atmosphere with a heating rate of 5° C./min, then naturally cooled to room temperature, and ground to obtain a PtRe/PC alloy catalyst (based on the total amount of platinum-rhenium alloy catalyst, the total mass percentage of platinum and rhenium metal was 18.85 wt %, the molar ratio of platinum to rhenium was 0.98:1).

### Example 4

A PtRe/PC alloy catalyst was prepared according to the flow chart shown in FIG. 1. The specific steps were as follows.

(1) 80 mg of EC-300J carbon black was took and dispersed ultrasonically in 50 mL of ethylene glycol for 30 minutes. During the stirring process, to the resulting mixture was added dropwise 5 mL of chloroplatinic acid-ethylene glycol solution with a concentration of 4 mgPt/mL, and then added dropwise 5 mL of potassium hydroxide-ethylene glycol solution with a concentration of 1 mol/L (the molar ratio of chloroplatinic acid to potassium hydroxide is 1:50), and the resulting uniform slurry was transferred to a microwave reactor and reacted at 140° C. for 10 min with a power of 900 W.

(2) After the reacted solution was naturally cooled to room temperature, 0.5 mol/L dilute hydrochloric acid solution was added to it to adjust the pH to about 4. The platinum nanoparticles were deposited in the acidic environment for 15 hours, and then rinsed with a large amount of deionized water, dried under vacuum at 60° C. to obtain a Pt/C precursor.

(3) 1.5 mL of phosphoric acid solution with a concentration of 0.1 mol/L and 0.5 mL of sodium perrhenate solution with a concentration of 0.1 mol/L were took and added to 10 mL of a suspension of the Pt/C precursor (its concentration was 10 mg/mL). Ultrasonic treatment was carried out for 120 min with a power of 500 W, followed by drying at 70° C., grinding and crushing.

(4) The powder was calcined at 800° C. for 90 minutes in a hydrogen-argon mixed gas atmosphere, with a heating rate of 5° C./min, then naturally cooled to room temperature, and ground to obtain a PtRe/PC alloy catalyst (based on the total amount of the platinum-rhenium alloy catalyst, the total mass percentage of platinum and rhenium metal was 26.81 wt %, and the molar ratio of platinum to rhenium was 2.00:1).

### Example 5

A PtRe/PC alloy catalyst was prepared according to the flow chart shown in FIG. 1. The specific steps were as follows.

(1) 80 mg of EC-300J carbon black was took and dispersed ultrasonically in 50 mL of ethylene glycol for 30 minutes. During the stirring process, to the resulting mixture was added dropwise 5 mL of chloroplatinic acid-ethylene glycol solution with a concentration of 4 mgPt/mL, and then added dropwise 8 mL of potassium hydroxide-ethylene glycol solution with a concentration of 1 mol/L (the molar ratio of chloroplatinic acid to potassium hydroxide is 1:80), and the resulting uniform slurry was transferred to a microwave reactor and reacted at 140° C. for 10 min with a power of 900 W.

(2) After the reacted solution was naturally cooled to room temperature, to the solution was added 0.5 mol/L dilute hydrochloric acid solution to adjust the pH to about 4. The platinum nanoparticles were deposited in the acidic environment for 15 hours, and then rinsed with a large amount of deionized water, dried under vacuum at 60° C. to obtain a Pt/C precursor.

(3) 1.5 mL of phosphoric acid solution with a concentration of 0.1 mol/L and 0.5 mL of sodium perrhenate solution with a concentration of 0.1 mol/L were took and added to a 10 mL suspension of the Pt/C precursor (its concentration was 10 mg/mL). Ultrasonic treatment was carried out for 120 min with a power of 500 W, followed by drying at 70° C., grinding and crushing.

(4) The powder was calcined at 800° C. for 90 minutes in a hydrogen-argon mixed gas atmosphere, with a heating rate of 5° C./min, then naturally cooled to room temperature, and ground to obtain a PtRe/PC alloy catalyst (based on the total amount of the platinum-rhenium alloy catalyst, the total mass percentage of platinum and rhenium metal was 26.77 wt %, and the molar ratio of platinum to rhenium was 2.01:1).

### Example 6

A PtRe/PC alloy catalyst was prepared according to the flow chart shown in FIG. 1. The specific steps were as follows.

(1) 80 mg of BP2000 carbon black was took and dispersed ultrasonically in 35 mL of ethylene glycol for 30 minutes. During the stirring process, to the resulting mixture was added 5 mL of chloroplatinic acid-ethylene glycol solution with a concentration of 4 mgPt/mL dropwise, and then added 5 mL of potassium hydroxide-ethylene glycol solution with a concentration of 1 mol/L (the molar ratio of chloroplatinic acid to potassium hydroxide is 1:50) dropwise, and the resulting uniform slurry was transferred to a microwave reactor and reacted at 160° C. for 10 min with a power of 700 W.

(2) After the reacted solution is naturally cooled to room temperature, to the mixture was added 0.5 mol/L dilute hydrochloric acid solution to adjust the pH to about 2. The platinum nanoparticles were deposited in the acidic environment for 24 hours, and then rinsed with a large amount of deionized water, dried under vacuum at 60° C. to obtain a Pt/C precursor.

(3) 1 mL of sodium dihydrogen phosphate solution with a concentration of 0.1 mol/L and 0.5 mL of rhenium trichloride solution with a concentration of 0.1 mol/L were took and added to a 10 mL of a suspension of the Pt/C precursor (its concentration was 10 mg/mL) for 120 min at a power of 600 W, followed by drying at 60° C., grinding and crushing.

(4) The powder was calcined at 600° C. for 120 min under an argon atmosphere with a heating rate of 10° C./min, then naturally cooled to room temperature, and ground to obtain a PtRe/PC alloy catalyst (based on the total amount of platinum-rhenium alloy catalyst, platinum and the total mass percentage of rhenium metal was 26.89 wt %, and the molar ratio of platinum to rhenium was 1.98:1).

### Comparative Example 1

A catalyst was prepared according to Example 1, except that no phosphorus source was added. The specific steps were as follows:

(1) 80 mg of Vulcan XC-72R carbon black was took and dispersed ultrasonically in 25 mL of ethylene glycol for 30 minutes. During the stirring process, to the resulting mixture was added dropwise 5 mL of chloroplatinic acid-ethylene glycol solution with a concentration of 4 mgPt/mL, and then added dropwise 5 mL of sodium hydroxide-ethylene glycol solution with a concentration of 1 mol/L (the molar ratio of chloroplatinic acid to sodium hydroxide is 1:50), and the resulting uniform slurry was transferred to a microwave reactor and reacted at 160° C. for 2 min with a power of 900 W.

(2) After the reacted solution was naturally cooled to room temperature, to the resulting mixture was added 0.5 mol/L dilute sulfuric acid solution to adjust the pH to about 2. The platinum nanoparticles were deposited in the acidic environment for 20 hours, and then rinsed with a large amount of deionized water. A Pt/C precursor was obtained by freeze-drying.

(3) 0.4 mL of rhenium trichloride solution with a concentration of 0.1 mol/L was took, and added to a 10 mL suspension of the Pt/C precursor (its concentration was 10 mg/mL). Ultrasonic treatment was carried out for 120 min with a power of 500 W, followed by drying at 60° C., grinding and crushing.

(4) The powder was calcined at 700° C. for 120 minutes under a N2 atmosphere with a heating rate of 5° C./min, then naturally cooled to room temperature, and ground to obtain a Pt-based catalyst.

### Comparative Example 2

The catalyst was prepared according to Example 1, except that no rhenium source was added. The specific steps were as follows.

(1) 80 mg of Vulcan XC-72R carbon black was took and dispersed ultrasonically in 25 mL of ethylene glycol for 30 minutes. During the stirring process, to the resulting mixture was added dropwise 5 mL of chloroplatinic acid-ethylene glycol solution with a concentration of 4 mgPt/mL, and then added dropwise 5 mL of sodium hydroxide-ethylene glycol solution with a concentration of 1 mol/L (the molar ratio of chloroplatinic acid to sodium hydroxide is 1:50), and the resulting uniform slurry was transferred to a microwave reactor and reacted at 160° C. for 2 min with a power of 900 W.

(2) After the reacted solution was naturally cooled to room temperature, to the resulting mixture was added 0.5 mol/L dilute sulfuric acid solution to adjust the pH to about 2. The platinum nanoparticles were deposited in the acidic environment for 20 hours, and then rinsed with a large amount of deionized water. A Pt/C precursor was obtained by freeze-drying.

(3) 1 mL of sodium dihydrogen phosphate solution with a concentration of 0.1 mol/L was took, and added to a 10 mL suspension of the Pt/C precursor (its concentration was 10 mg/mL). Ultrasonic treatment was carried out for 120 min with a power of 500 W, followed by drying at 60° C., grinding and crushing.

(4) The powder was calcined at 700° C. for 120 minutes under a N2 atmosphere with a heating rate of 5° C./min, then naturally cooled to room temperature, and ground to obtain a Pt-based catalyst.

### Comparative Example 3

A Pt/C precursor catalyst was prepared according to Example 1, and the specific steps were as follows:

(1) 80 mg of Vulcan XC-72R carbon black was took and dispersed ultrasonically in 25 mL of ethylene glycol for 30 minutes. During the stirring process, to the resulting mixture was added dropwise 5 mL of chloroplatinic acid-ethylene glycol solution with a concentration of 4 mg. Pt/mL, and then added dropwise 11 mL of sodium hydroxide-ethylene glycol solution with a concentration of 1 mol/L (the molar ratio of chloroplatinic acid to sodium hydroxide is 1:110), and the resulting uniform slurry was transferred to a microwave reactor and reacted at 180° C. for 5 min with a power of 900 W.

(2) After the reacted solution was naturally cooled to room temperature, to the resulting mixture was added 0.5 mol/L dilute nitric acid solution to adjust the pH to about 3. The platinum nanoparticles were deposited in an acidic environment for 20 hours, and then rinsed with a large amount of deionized water. A Pt/C precursor catalyst was obtained by freeze-drying.

The PtRe/PC alloy catalyst prepared in Examples 1-6 and the catalyst prepared in Comparative Examples 1-3 were used for the working electrode test. The test method was shown in Example 1, and the results are shown in Table 1.

TABLE 1
Comparison of half-wave potential, mass activity,
total mass percentage, and platinum-rhenium molar
ratio of the catalysts prepared in each example.

| | Half- | | Total Mass | |
|---|---|---|---|---|
| | wave | Mass Activity/ | Percentage of | Molar Ratio |
| Catalyst | Potential/ | mA mgPt − | Platinum and | of Platinum |
| Sample | V | 1(0.9 V) | Rhenium/wt % | to Rhenium |
| Example 1 | 0.8622 | 0.382 | 25.54 | 2.49:1 |
| Example 2 | 0.8542 | 0.347 | 18.77 | 1.02:1 |
| Example 3 | 0.8312 | 0.289 | 18.85 | 0.98:1 |
| Example 4 | 0.8482 | 0.319 | 26.81 | 2.00:1 |
| Example 5 | 0.8522 | 0.324 | 26.77 | 2.01:1 |
| Example 6 | 0.8682 | 0.365 | 26.89 | 1.98:1 |
| Comparative | 0.8172 | 0.152 | 19.98 | — |
| Example 1 | | | | |
| Comparative | 0.8212 | 0.147 | 20.67 | — |
| Example 2 | | | | |
| Comparative | 0.8182 | 0.150 | 19.87 | — |
| Example 3 | | | | |

It can be seen from the above table that the platinum-rhenium alloy catalyst for fuel cell prepared by the process of the present invention exhibits excellent electrochemical properties. In particular, the half-wave potential of the catalyst in Example 1 can reach 0.8622V, and the mass activity is 0.382 mA/mgPt (0.9V). In addition, the preparation method is simple and easy to implement, and is suitable for large-scale production.

Compared Example 1 with Comparative Examples 2-3, it is found that the platinum-rhenium alloy catalyst has better electrochemical performance than the platinum catalyst due to the addition of rhenium. The present invention reduces the use of platinum resources, and at the same time, the introduction of rhenium adjusts the electronic structure of platinum and improves the catalytic ability.

Comparing Example 1 and Comparative Examples 1-3, it is found that the electrocatalytic performance of the platinum-rhenium alloy catalyst of Example 1 is significantly better than those of Comparative Examples 1-2, and there is no significant difference in the electrochemical performance of Comparative Examples 1-3. This is because the decomposition products of the phosphorus source generated at high temperatures drive the reduction of rhenium and its alloying with platinum. The present invention prepares a platinum-rhenium alloy catalyst through a two-step method comprising pyrolyzing the phosphorus source at high temperature to alloy rhenium and platinum, solves the problem of difficulty in simultaneous reduction caused by the difference in reduction potential of platinum and rhenium, and provides a new idea for the preparation of platinum-rhenium alloy.

The present invention has been described in detail above. For those skilled in the art, the present invention can be implemented in a wider range under equivalent parameters, concentrations and conditions without departing from the spirit and scope of the present invention. Although specific embodiments of the present invention have been shown, it should be understood that further modifications can be made to the invention. In short, based on the principles of the present invention, this application is intended to include any changes, uses, or improvements to the present invention, including changes that depart from the scope disclosed in this application and are made using conventional techniques known in the art.

1. A method for preparing platinum-rhenium alloy catalyst, comprising the following steps:
(1) dispersing a carbon carrier, a platinum source and an alkaline substance in ethylene glycol for microwave reaction, acidizing and depositing the solution after the reaction is finished, washing with water, and drying to obtain a Pt/C precursor;
(2) dispersing the Pt/C precursor, a phosphorus source and a rhenium precursor in water, carrying out ultrasonic treatment, drying by distillation after the ultrasonic treatment, and grinding to obtain a platinum-rhenium alloy catalyst precursor; and
(3) calcining the platinum-rhenium alloy catalyst precursor in an inert atmosphere, and grinding after treatment to obtain the platinum-rhenium alloy catalyst.

2. The preparation method of platinum-rhenium alloy catalyst according to claim 1, wherein:
the carbon carrier is carbon black, preferably at least one of Vulcan XC-72R, EC-300J, EC-600J, and BP2000;
the platinum source is at least one of chloroplatinic acid, potassium chloroplatinate, sodium chloroplatinate, and platinum acetylacetonate;
the alkaline substance is at least one of sodium hydroxide, potassium hydroxide, and ammonia water;
a molar ratio of the platinum source to the alkaline substance is 1:(20-110);
a volume ratio of the total mass of the carbon carrier, the platinum source and the alkaline substance to the ethylene glycol is (2 to 20) mg:1 mL;
a power of the microwave reaction is 600-900 W, the temperature is 130° C.-190° C., and the time is 2 min-30 min.

3. The method for preparing platinum-rhenium alloy catalyst according to claim 1, wherein:
in the step of acidizing and depositing, an acid is added to the solution to adjust the pH value of the solution to 2 to 4;
the acid is at least one of dilute hydrochloric acid, dilute nitric acid, and dilute sulfuric acid;
a time of the acidizing and depositing is 5 to 24 hours.

4. The method for preparing platinum-rhenium alloy catalyst according to claim 1, wherein:
the phosphorus source is at least one of phosphoric acid, sodium hydrogen phosphate, sodium dihydrogen phosphate, and sodium hydrogen hypophosphite;
the rhenium precursor is at least one of perrhenic acid, sodium perrhenate, rhenium trichloride, and rhenium oxide; and
a molar ratio of the phosphorus source to the rhenium precursor is 1:(0.1-2).

5. The method for preparing platinum-rhenium alloy catalyst according to claim 1, wherein:
a volume ratio of the total mass of the Pt/C precursor, the phosphorus source and the rhenium precursor to water is (5-30) mg:1 mL;
a power of the ultrasonic treatment is 500-1000 W, and a time of the ultrasonic treatment is 30-120 minutes.

6. The method for preparing platinum-rhenium alloy catalyst according to claim 1, wherein:
the inert atmosphere is nitrogen, argon or a hydrogen-argon mixture;
conditions for the calcinating treatment are as follows: the temperature is raised to 600-1100° C. at a heating rate of 2-5° C./min, and held for 1-4 hours.

7. The method for preparing platinum-rhenium alloy catalyst according to claim 1, wherein:
based on the total amount of the platinum-rhenium alloy catalyst, a total mass percentage of platinum and rhenium metal is 10% to 40%.

8. The method for preparing platinum-rhenium alloy catalyst according to claim 1, wherein:
in the platinum-rhenium alloy catalyst, the molar ratio of platinum to rhenium is (1-3):1.

9. A platinum-rhenium alloy catalyst prepared by the method for preparing platinum-rhenium alloy catalyst according to claim 1.

10. A hydrogen fuel cell, comprising a cathode, an anode and an electrolyte, wherein:
the cathode comprises the platinum-rhenium alloy catalyst of claim 9.
